(19) United States
(12) Patent Application Publication
(10) Pub. No.: US 2006/0129893 A1
(43) Pub. Date: Jun. 15, 2006

(54) Apparatus, system, and method for criteria driven summarization of trace entry data

(76) Inventor: Alan Ray Smith, Gilroy, CA (US)

Correspondence Address: KUNZLER & ASSOCIATES, 8 EAST BROADWAY, SUITE 600, SALT LAKE CITY, UT, 84111, US

(21) Appl. No.: 11/256,720

(22) Filed: Oct. 24, 2005

Related U.S. Application Data
(63) Continuation-in-part of application No. 10/999,452, filed on Nov. 30, 2004.

(51) Int. Cl. G06F 11/00

(52) U.S. Cl. 714/38

(57) ABSTRACT

An apparatus, system, and method are disclosed for criteria driven summarization of trace entry data. The apparatus includes an interface module that receives summary criteria including a set of field identifiers, the field identifiers specifying particular segments of trace entry data to be summarized. A scanning module scans a set of trace entries, and a tabulating module tabulates a count for each set of unique values within the set of trace entries corresponding to the associated field identifiers. A results module generates one or more result sets including the tabulated counts. Additionally, summaries of trace data may be generated according to specified time stamp boundaries, time intervals, or trace entry type.

### CROSS-REFERENCES TO RELATED APPLICATIONS

This application is a continuation-in-part of and claims priority to U.S. patent application Ser. No. 10/999,452 entitled “APPARATUS, SYSTEM, AND METHOD FOR ANALYZING TRACE DATA” and filed on Nov. 30, 2004 for Alan Ray Smith, which is incorporated herein by reference.

### BACKGROUND OF THE INVENTION

1. Field of the Invention

This invention relates to trace data and more particularly relates to summarizing trace data based on a set of summary criteria.

2. Description of the Related Art

Computer software generally includes a trace feature that may be used during development or during normal operation of a software application. The trace feature causes the software application to report various types of information regarding the inputs received, outputs generated, functions called, return codes received, and other highly detailed information known herein as trace data. Generally, trace data is analyzed by software engineers or programmers to facilitate resolving software bugs and/or inefficiencies in the software application.

Trace data is typically stored for subsequent analysis after the software application is executed to generate the software error. Because trace data is generally only collected during high workload periods for the computer system and/or software application, it is desirable that the tracing operation add minimal overhead to the workload. Consequently, the frequently-generated trace entries are typically combined into larger groups of trace entries, known herein as trace records. The trace records often include a header that identifies the number of trace entries contained therein as well as other context information such as trace type and a timestamp. Trace records can be over one hundred times larger than individual trace entries. Storing the larger trace records requires less I/O than storing individual trace entries but can be more difficult to analyze.

Trace data can be collected during a single execution or over a period of time in order to identify more latent software bugs. Consequently, the size of the trace data grows dramatically. Analyzing such high quantities of trace data has been difficult for programmers, in particular, where the trace data is formatted and presented in a text format for values such as hexadecimal. The trace data can include few, if any, cues for a programmer such as keywords. This makes it very difficult and time consuming to analyze the trace data where currently available search utilities such as DFSERA10 and DFSERA70 provided with the Information Management System (IMS) from IBM of Armonk, N.Y, do not permit searching for or summarizing data values within trace entries individually.

In order to more effectively analyze the trace entry data within an unstructured trace record, an existing tool provides structural reference to an unstructured trace record. That tool makes possible a search through a trace record and delineates the trace entries contained in raw data sets. A search for particular data or data segments within the trace entries can further facilitate the analyzing of trace entry data. However, a need still exists to summarize the data contained in either the abridged trace record or the raw data, such that a user may identify fields within the trace entries for summarization and generate a set of results showing the fields of interest and their relation to each other. Additionally, the data may need to be summarized according to time intervals or trace entry type in order to be useful. This would allow a user to more easily analyze the data and discover inefficiencies in the applicable software.

From the foregoing discussion, it should be apparent that a need exists for an apparatus, system, and method to summarize trace entry data according to defined criteria. Beneficially, such an apparatus, system, and method would allow the detection of software behavioral trends and peak activity within specific fields of trace entry data allowing for faster and more accurate software debugging.

### SUMMARY OF THE INVENTION

The present invention has been developed in response to the present state of the art, and in particular, in response to the problems and needs in the art that have not yet been fully solved by currently available trace analysis utilities. Accordingly, the present invention has been developed to provide an apparatus, system, and method for criteria driven summarization of trace entry data that overcome many or all of the above-discussed shortcomings in the art.

The apparatus to summarize trace entry data is provided with a logic unit containing a plurality of modules configured to functionally execute the necessary steps of criteria driven summarization. These modules in the described embodiments include an interface module, a scanning module, a tabulating module, and a results module.

The interface module receives summary criteria comprising a set of field identifiers. The summary criteria may also include but is not limited to time interval specifications, time stamp boundary definitions, and trace entry types. In one embodiment, the summary criteria may be selectively defined by a user, and the field identifiers may specify a segment size and segment location in a trace entry. In one embodiment, a second summary criteria set may be received resulting in the generation of at least one result set corresponding to each summary criteria set such that the set of trace entries is scanned once.

The scanning module scans a set of trace entries as specified by the received summary criteria. In one embodiment the scanning module determines one or more sets of unique values within the set of trace entries, the unique values corresponding to associated field identifiers within the set of field identifiers. The one or more sets of unique values may be used to establish counters for use by the tabulating module. In one embodiment, the scanning module may also filter the set of trace entries based on a trace identifier for specifying a trace entry type where the trace identifier is provided in the summary criteria.

The tabulating module tabulates a count for each set of unique values within the set of trace entries, the unique values corresponding to associated field identifiers within the defined set of field identifiers. In one embodiment, the set of trace entries is divided into time intervals as specified by the summary criteria and a count is tabulated for each set of unique values within each specified time interval as well as the entire range of time specified by the time stamp boundaries.

The results module is configured to generate one or more result sets comprising the tabulated counts. In one embodiment, one or more result sets are generated corresponding to time intervals specified in the summary criteria. In an additional embodiment, a second summary criteria set is received and at least one result set is generated corresponding to each summary criteria set such that the set of trace entries is scanned once. The results sets, in one embodiment, are presented to the user.

The apparatus may further include dividing an unstructured trace record logically into two or more trace entries based on structural information; applying a query expression comprising a condition and one or more parameters to each entry; and assembling each entry that satisfies the query expression into the set of trace entries.

A system of the present invention is also presented to summarize trace entry data. The system may include the modules of the apparatus. In addition, the system, in one embodiment, includes a processor, a storage device, Input/Output (I/O) devices, a communication bus, and a memory. The processor executes software to manage operations of the system. The storage device stores a plurality of unstructured trace records, and the I/O devices interact with a user. The communication bus operatively couples the processor, storage device, I/O devices, and memory.

The memory may include the modules of the apparatus, specifically the interface module, scanning module, tabulating module, and results module. A user may provide the summary criteria to the receiving module through the I/O devices.

A method of the present invention is also presented for analyzing trace entry data. The method in the disclosed embodiments substantially includes the steps necessary to carry out the functions presented above with respect to the operation of the described apparatus and system. In one embodiment, the method includes executing a trend analysis utility comprising the modules in embodiments of the apparatus described above. The method also may include analyzing the one or more result sets to identify software operation trends indicated by the counts.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for summarizing trace entry data in accordance with the present invention;

FIG. 2 is a schematic block diagram illustrating one embodiment of a trend analysis utility for summarizing trace entry data in accordance with the present invention;

FIG. 3 is a schematic block diagram illustrating a trace data set comprising a plurality of trace records suitable for use with the present invention;

FIG. 4 is a schematic block diagram illustrating the logical structuring of a trace entry suitable for use with one embodiment of an apparatus in accordance with the present invention;

FIG. 5 is a schematic flow chart diagram illustrating one embodiment of a trace entry summarization method in accordance with the present invention; and

FIG. 6 is a schematic flow chart diagram illustrating one embodiment of a trace entry analysis method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or finction. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The term “programmed method”, as used herein, is defined to mean one or more process steps that are presently performed; or, alternatively, one or more process steps that are enabled to be performed at a future point in time. This enablement for future process step performance may be accomplished in a variety of ways. For example, a system may be programmed by hardware, software, firmware, or a combination thereof to perform process steps; or, alternatively, a computer-readable medium may embody computer readable instructions that perform process steps when executed by a computer.

The term “programmed method” anticipates four alternative forms. First, a programmed method comprises presently performed process steps. Second, a programmed method comprises a computer-readable medium embodying computer instructions, which when executed by a computer, perform one or more process steps. Third, a programmed method comprises an apparatus having hardware and/or software modules configured to perform the process steps. Finally, a programmed method comprises a computer system that has been programmed by software, hardware, firmware, or any combination thereof, to perform one or more process steps.

It is to be understood that the term “programmed method” is not to be construed as simultaneously having more than one alternative form, but rather is to be construed in the truest sense of an alternative form wherein, at any given point in time, only one of the plurality of alternative forms is present. Furthermore, the term “programmed method” is not intended to require that an alternative form must exclude elements of other alternative forms with respect to the detection of a programmed method in an accused device.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

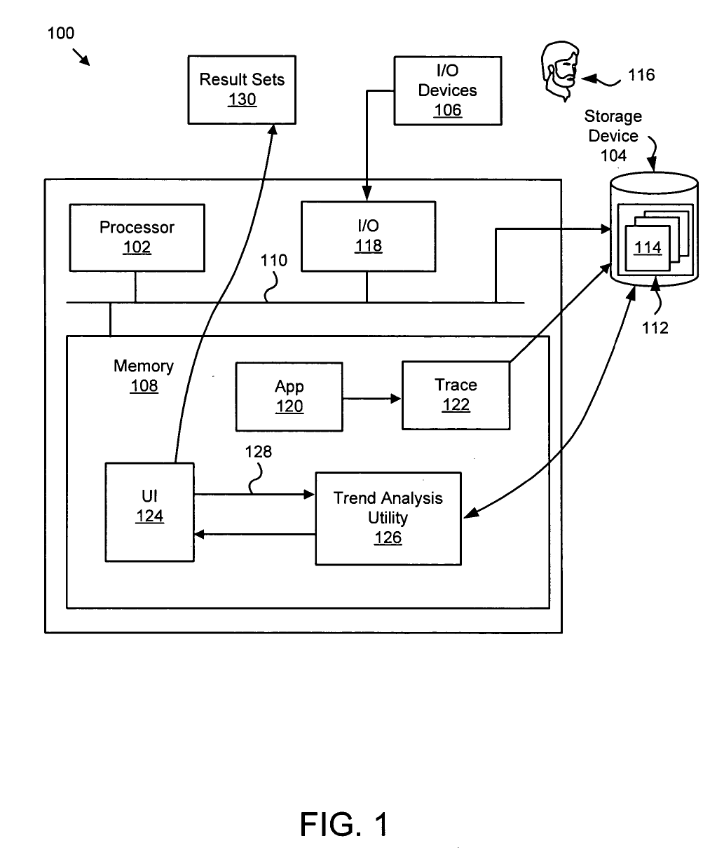

FIG. 1 depicts one embodiment of a system 100 for summarizingtrace entry data in accordance with the present invention. The system 100 includes a processor 102, a storage device 104, I/O devices 106, a memory 108, and a communication bus 110. Those of skill in the art recognize that the system 100 may be more simple or complex than illustrated so long as the system 100 includes modules or sub-systems that correspond to those described herein. In one embodiment, the system 100 comprises hardware and/or software more commonly referred to as a Multiple Virtual Storage (MVS), OS/390, zSeries/Operating System (z/OS), UNIX, Linux, or Windows.

Typically, the processor 102 comprises one or more central processing units executing software and/or firmware to control and manage the other components within the system 100. The storage device 104 provides persistent storage of data. In particular, the storage device 104 stores one or more data sets 112. Each data set 112 may include a plurality of records, for example trace records 114.

The I/O devices 106 permit a user 116 to interface with the system 100. In one embodiment, the user 116 provides summary criteria to the system 100. Alternatively, summary criteria may be stored in a script, software code, or the like. The I/O devices 106 include standard devices such as a keyboard, monitor, mouse, and the like. The I/O devices 106 are coupled to the communication bus 110 via one or more I/O controllers 118 that manage data flow between the components of the system 100 and the I/O devices 106.

The communication bus 110 operatively couples the processor 102, memory 108, I/O controllers 118, and storage device 104. The communication bus 110 may implement a variety of communication protocols including Peripheral Communications Interface, Small Computer System Interface and the like.

The memory 108 may include an application 120, a trace module 122, a User Interface (UI) 124, and a trend analysis utility 126. The application 120 may comprise any software application configured to interface with the trace module 122. For example, the application 120 may comprise a transaction and database management system such as Information Management System (IMS) from IBM.

The trace module 122 comprises a software module configured to monitor an application 120 and generate trace entries representative of certain operations, data, and events that occur in relation to the application 120. The trace module 122 is further configured to minimize I/O overhead in the system 100 by bundling a plurality of trace entries into an unstructured trace record that the trace module 122 stores in trace data sets 112. The trace module 122 may be integrated with, or separate from, the application 120.

When a user 116 desires to summarize trace entry data, the user 116 selectively defines summary criteria 128 within the UI 124. The summary criteria 128 may include but is not limited to a set of field identifiers, time stamp boundaries, time interval specifications, and trace entry types. In one embodiment, the set of field identifiers comprises a segment size and a segment location within a trace entry and may be a specific word, half-word, or byte. The time interval specifications may indicate that summaries of the trace entry data should be created for each time interval specified as well as the entire time period defined by the time stamp boundaries. For example, if the data set being summarized includes two hours worth of data, the time stamp boundaries may delineate a one hour block of time, and the time interval specification may indicate that a separate summary should be created for every twenty minutes worth of data within that one hour block of time. In one embodiment, this would result in four summarizations, three summaries for each twenty minute time interval and another summary for the entire one hour block specified. The trace entry type simply allows a summarization to be limited to a certain trace entry type while eliminating other trace entry types.

The UI 124 provides the summary criteria 128 to the trend analysis utility 126. In one embodiment, based on the summary criteria 128, the trend analysis utility 126 retrieves the trace entry data to be summarized from the storage device 104. The trace entry data may include a particular data set 112 in one embodiment, a set of trace records 114, an abridged record set that has been created by a search utility, or other trace entry data sets as will be recognized by one skilled in the art. The trend analysis utility 126 applies summary criteria to the set of trace entry data by scanning the set of trace entries and tabulating a count for each set of unique values within the set of trace entries, the unique values corresponding to associated field identifiers within the set of field identifiers specified by the summary criteria 128. In order to establish counters for each unique set of values, the tabulation, in one embodiment, may include determining one or more sets of unique values within the set of trace entries, the unique values also corresponding to field identifiers specified in the summary criteria 128.

The trend analysis utility 126 generates one or more result sets 130 comprising the tabulated counts and presents them to the user 116. The result sets 130 may include results corresponding to time intervals, time stamp boundaries, or trace entry type as described above. In one embodiment, the user 116 may provide more than one summary criteria set 128. In this case, the result sets 130 may include results corresponding to each different set of summary criteria provided by the user.

In one embodiment, the trace entry data is searched and abridged before summarization takes place. When the user 116 desires to search and abridge a trace data set 112, the user 116 may define a query expression within the UI 124. Rather thanjust a simple search string as in conventional systems, the query expression comprises a condition and one or more parameters. The condition and parameters permit the user 116 more control over the search results. The UI 124 provides the query expression to the trend analysis utility 126. Based on the parameters, the trend analysis utility 126 retrieves the trace records 114 for a particular trace data set 112. The trend analysis utility 126 applies the query expression, including the condition and one or more parameters, to each entry within the trace records. In one embodiment, this may include dividing an unstructured trace record logically into two or more trace entries based on structural information. Trace entries that satisfy the condition are assembled into one or more abridged trace records and trace entries that fail to satisfy the condition are discarded. Once the records are abridged as desired, summarization of the abridged records may take place in accordance with the present invention.

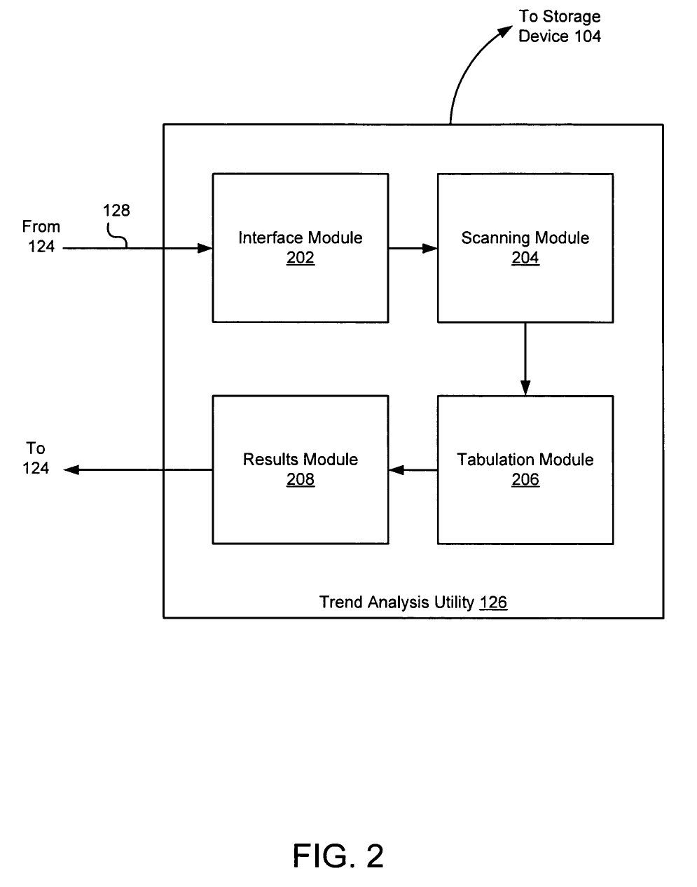

FIG. 2 is a schematic block diagram illustrating one embodiment of the trend analysis utility 126 in accordance with the present invention. The trend analysis utility 126 may include but is not limited to an interface module 202, a scanning module 204, a tabulation module 206, and a results module 208. The included modules contain the logic necessary to perform the necessary steps of summarizing trace entry data. The trend analysis utility 126, in one embodiment, is in communication with the UI 124 and the storage device 104. The UI 124 may provide input from the user 116 to the trend analysis utility 126 in the form of summary criteria 128.

The interface module 202 receives the summary criteria 128 and passes the instructions contained therein to the scanning module 204. The summary criteria 128, as described above, may specify trace entry type, time interval divisions, time stamp boundaries, and may include a set of field identifiers. There are multiple types of trace records, each type may be associated with a two-character trace identifier. Summary reports can be generated for trace entries pertaining to specific entry types, or for all of the trace entry types represented in a data set. Time intervals may also be specified for dividing data sets according to time specifications and generating summary results for each specified interval as well as the entire time span. Time stamp boundaries simply delineate the time span to be included in the summary with the time intervals dividing the time span into smaller intervals. The field identifiers define which segment size and segment location within a trace entry is to be summarized as is described in detail below. Multiple summary criteria sets 128 can also be specified allowing multiple summaries to be generated with a single command, an independent result set may be created for each summary criteria set 128 specified.

The scanning module 204 scans a set of trace entries in accordance with the summary criteria 128. In one embodiment, the scanning module 204 may retrieve trace entry data from a storage device 104 and store the trace entry data in a memory 108 where the scanning takes place. In an alternate embodiment, the scanning module 204 simply scans the trace entry data located in the storage device 104 without first moving the trace entry data to a temporary location. The trace entry data may be stored in many forms including an unstructured data set, a set of trace records, or an abridged set of trace entries as will be recognized by one skilled in the art. The scanning module 204 scans the data set specified by the summary criteria 128 and communicates the information from the defined fields to the tabulation module 206.

The tabulation module 206 is configured to tabulate a count for each set of unique values within the set of trace entries, the unique values corresponding to associated field identifiers within the set of field identifiers specified by the summary criteria 128. As the scanning module 204 scans each trace entry, it identifies the values stored in the fields defined by the set of field identifiers, and sends the information to the tabulation module 206. This may include determining when a new value is found so a new count for that value can be initiated. The tabulation module 206 increments the count corresponding to a given value each time that value is found in a different trace entry.

The results module 208 generates one or more result sets comprising the tabulated counts. Once the scanning module 204 finishes scanning the data set, and the tabulation module 206 finishes tabulating the counts for the fields of interest, the results module 208 generates result sets that summarize the data by providing the tabulated counts from the tabulation module 206 in a structured form. The results module 208 may also present the results to the user 116 via the I/O devices 106. The results may be presented in table form, graphical form, or other useful form as will be recognized by one skilled in the art. In an alternate embodiment, the result sets 130 are stored for later viewing, possibly in a memory 108 or storage device 104.

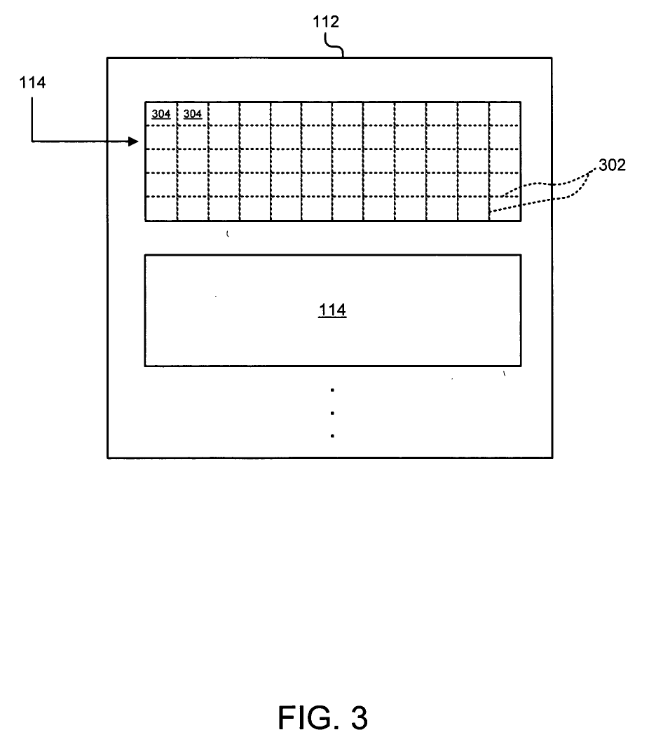

FIG. 3 is a schematic block diagram illustrating one embodiment of a trace data set 112 comprising a set of trace records 114 suitable for use with the trend analysis utility 126. Conventionally, to optimize I/O when trace data sets 112 are generated, a plurality of trace entries written to the storage device 104 are grouped within a single trace record 114. One of skill in the art will note that the trace records 114 may include no structuring. There may be no columns, fields, offsets, or other structural information stored with the trace record 114. To the storage device 104 and conventional search utilities, the trace record 114 is a contiguous set of unstructured data. By imposing a logical structure 302 on the unstructured trace records 114, the data can be more easily searched and summarized. In certain embodiments, the logical structure 302 divides the unstructured trace record 114 into a plurality of trace entries 304. Preferably, the unstructured trace record 114 divides evenly into a plurality of trace entries 304.

In a preferred embodiment, the trace record 114 is logically divided into trace entries 304. Alternatively, the trace record 114 is physically divided into trace entries 304. As used herein, logical division of an unstructured trace record 114 means the record is processed in such a manner that the trace entries 304 and/or trace sub-entries are independently identified for application of a query expression and summary criteria 128. In one embodiment, the query expression, comprising a condition and one or more parameters, is applied to each entry so that each entry satisfying the query expression can be assembled into an abridged form. The trend analysis utility 126 may be used to summarize trace entry data from the structured or unstructured forms.

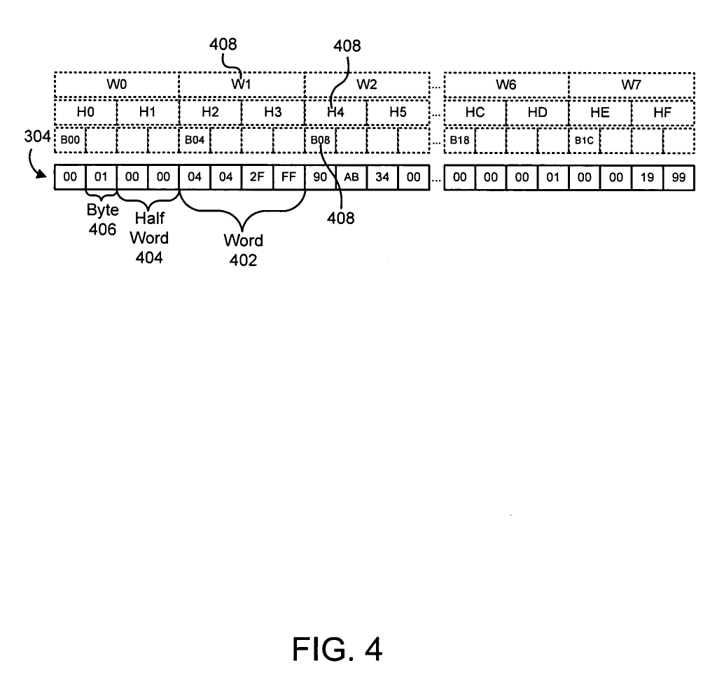

FIG. 4 is a schematic block diagram illustrating one embodiment of a trace entry 304 in accordance with the present invention. In one embodiment, the trace entry 304 is comprised of eight equal sized sub-entries herein referred to as words 402. Each word 402 is comprised of two equal size half-words 404. Each half-word 404 is comprised of two equal size bytes 406. Preferably, a byte 406 comprises eight bits.

In one embodiment, the field identifiers described above define a segment size and a segment location within a trace entry. The segment size and segment location may, in certain embodiments, correspond to the words 402, half-words 404, and bytes 406 depicted in FIG. 4. Typically, a trace entry 304 is thirty-two bytes in length so that there are eight words 402 and sixteen half-words 404. This makes denoting a segment size and location straight forward. For example, ‘W2’ may denote word two within the trace entry 304 wherein the words 402 are numbered W0, W1 . . . W7. This allows the sub-entries 408 of each trace entry 304 to be summarized and compared by the trend analysis utility 126.

An example of a set of trace entries 304 is provided in Table 1. Each horizontal line represents one thirty-two byte trace entry 304 such that the set listed below contains ten trace entries 304 in all. The notations above each column correspond to the size and location of each segment with the trace entries.

TABLE 1

| W0 | W1 | W2 | W3 | W4 | W5 | W6 | W7 |
|---|---|---|---|---|---|---|---|
| H0 H1 | H2 H3 | H4 H5 | H6 H7 | H8 H0 | HA HB | HC HD | HE HF |
| B00 | B04 | B08 | B0C | B10 | B14 | B18 | B1C |
| 00010000 | 04042FFF | 90AB3401 | 00000012 | 121234FF | FFFFFFFF | 00000001 | 00001999 |
| 00020000 | 04043000 | 90AB3402 | 00000089 | 121234FF | 00000000 | 00010001 | 00001999 |
| 00010000 | 04043001 | 90AB3403 | 00000034 | 121234EE | 12121212 | 00020001 | 00001999 |
| 00020000 | 04043002 | 90AB3404 | 00000055 | 121234AA | 00000000 | 00030001 | 00001999 |
| 00010000 | 04043003 | 90AB3405 | 00000034 | 121234BC | 00345692 | 00040001 | 00001999 |
| 00020000 | 04043004 | 90AB3406 | 00000090 | 121234CC | FFFFFFFF | 00050001 | 00001999 |
| 00010000 | 04043005 | 90AB3407 | 00000089 | 121234DD | 66666666 | 00060001 | 00001999 |
| 00020000 | 04043006 | 90AB3408 | 00000034 | 121234AA | FFFFFFFF | 00070001 | 00001999 |
| 00010000 | 04043007 | 90AB3409 | 00000012 | 121234FF | FFFFFFFF | 00060001 | 00001999 |
| 00020000 | 04043008 | 90AB340A | 00000012 | 12123499 | FFFFFFFF | 00040001 | 00001999 |

The summary criteria 128 may include a command to summarize H0 (Half-word Zero) based on the example in Table 1. In one embodiment, the result set generated may indicate a count for each value of H0 found within the set and a count of the total number of trace entries as depicted in Table 2.

TABLE 2

| SUMMARY | H0 |
|---|---|
| 5 | 0001 |
| 5 | 0002 |
| 10 | NUMBER OF TRACE ENTRIES |

In another example, the summary criteria 128 may include a command to summarize H0 and H7 (Half-word Seven). In one embodiment of this example the result set might include counts for each unique set of values stored in H0 and H7 together as depicted in Table 3.

TABLE 3

| SUMMARY | H0 | H7 |
|---|---|---|
| 2 | 0001 | 0012 |
| 2 | 0001 | 0034 |
| 1 | 0001 | 0089 |
| 1 | 0002 | 0012 |
| 1 | 0002 | 0034 |
| 1 | 0002 | 0055 |
| 1 | 0002 | 0089 |
| 1 | 0002 | 0090 |

| | |
|---|---|
| 10 | NUMBER OF TRACE ENTRIES |

The counts may be used to analyze software behavior trends by looking for high or low counts within specific data fields or by looking for relationships between different data fields. The summaries may also be generated for specific time intervals and time stamp ranges as well as particular trace entry types.

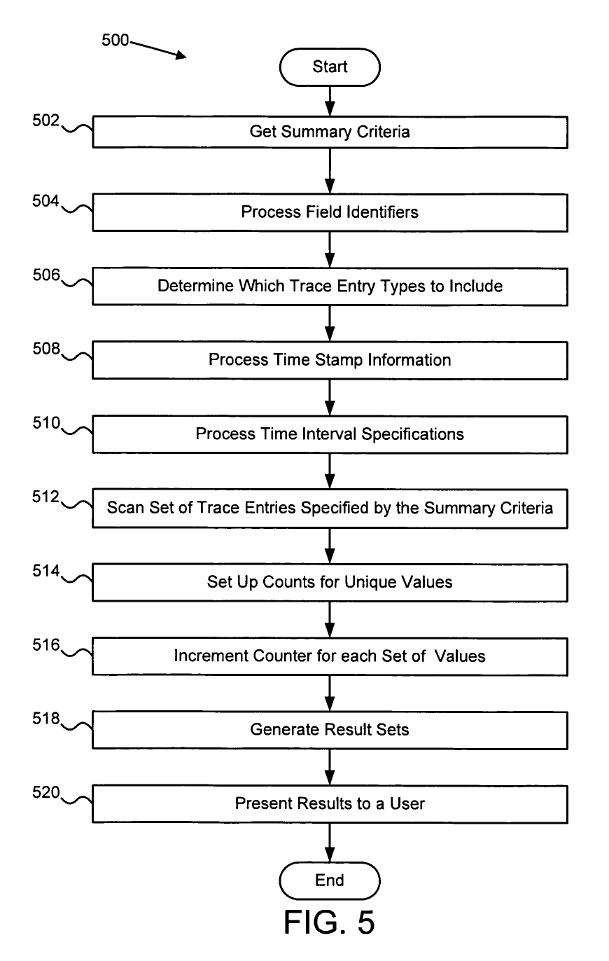

FIG. 5 is a flow chart diagram illustrating one embodiment of method 500 for summarizing trace entry data in accordance with the present invention. Preferably, the method 500 is implemented in a conventional system by deploying computer readable code including the trend analysis utility 126. The method 500 is initiated when a need arises to summarize a set of trace entries 304 satisfying a set of summary criteria 128. In certain embodiments, the user 116 provides 502 the summary criteria 128 for defining specifically which data fields are to be summarized. One or more field identifiers may be included in the summary criteria 128 and may correspond to specific words 402, half-words 404, or bytes 406 within the trace entries 304 that should be included in the summarization. The interface module 202 processes 504 the field identifiers included in the summary criteria 128. The interface module 202 also determines 506 which trace entry types should be included in the summary. In one embodiment, one or more trace entry types may be included, and in another embodiment, all trace entry types might be included in the summary. Trace entry type may be determined by a two-character trace identifier. In one embodiment each trace records 114 is associated with a particular trace identifier.

Next, time stamp boundaries included in the summary criteria 126 are processed 508 by the interface module 202. The time stamp boundaries specify a certain time span to be included in the summarization. For example, data covering several hours may be included in the data set but the user may only be interested in the data stored during a specific thirty minute period. The time stamp boundaries are used to delineate the data within this shorter time period from the larger data set. In one embodiment, no time stamp boundaries are specified so the entire data set is included. The interface module 202 may also process 510 time interval specifications indicating that summaries should be generated for specific time intervals within the time range specified by the time stamp boundaries. For example, a time interval of twenty minutes may be requested within a one hour time range. This would result in a summary of the trace entries within the one hour range as well as individual summaries for each twenty minute interval within the one hour range.

Next, the scanning module 204 scans 512 the set of trace entries specified by the summary criteria 128. Typically, the scanning process comprises reading each value within the data fields specified by the summary criteria 128. During the scanning process, the method 500 determines when a new unique set of values within a trace entry is found. Each time a new value is scanned, scanning module 204 sets up 514 an additional counter corresponding to the new value. The tabulation module 206 increments 516 each time one of the values is repeated. The results module 208 generates 518 the tabulated counts into result sets that may be presented 520 to the user or, in another embodiment, stored in memory. The results are used to identify software behavior trends and allow more efficient debugging of software problems.

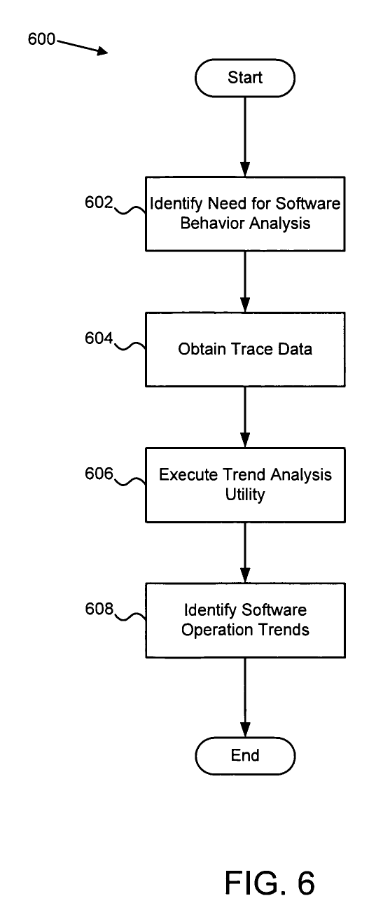

FIG. 6 is a schematic flow chart diagram illustrating one embodiment of a method 600 for analyzing trace entry data. The method 600 starts when a user identifies 602 a need for software behavior analysis. In one embodiment, this may include a customer reporting a software problem or poor software performance. In another embodiment, software behavior analysis may be needed as a means for improving upon a previous design or simply as part of testing the software. Once a need for analysis is identified 602, trace data is obtained 604. In one embodiment, the trace data may be transfered electronically to a remote site for analysis. In an alternate embodiment, the trace data may be accessed remotely across a network or the internet as will be recognized by one skilled in the art.

Next, a user executes 606 a trend analysis utility 126 such as the one described above, including the modules necessary to summarize trace entry data. In one embodiment, the trend analysis utility 126 produces result sets comprising summaries of the trace entry data that a user analyzes to identify 608 software operation trends. For example, the result sets may indicate, to one skilled in the art, a specific location in the code where a software bug occurs, or the result sets may indicate a specific time interval when a problem occurs. In this manner, the software can be debugged more efficiently than conventional methods.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A programmed method for summarizing trace entry data, the programmed method comprising:
receiving summary criteria comprising a set of field identifiers;
scanning a set of trace entries;
tabulating a count for each set of unique values within the set of trace entries, the unique values corresponding to associated field identifiers within the set of field identifiers; and
generating one or more result sets comprising the tabulated counts.

2. The programmed method of claim 1, wherein said programmed method is in the form of process steps.

3. The programmed method of claim 1 wherein said programmed method is in the form of a computer-readable medium embodying computer instructions for performing the process steps.

4. The programmed method of claim 1 wherein said programmed method is in the form of a computer system programmed by software, hardware, firmware, or any combination thereof, for performing the process steps.

5. The programmed method of claim 1 wherein said programmed method is in the form of an apparatus comprising software, hardware, firmware, or any combination thereof, for performing the process steps.

6. The programmed method of claim 1, wherein the summary criteria is selectively defined by a user.

7. The programmed method of claim 1, further comprising determining one or more sets of unique values within the set of trace entries, the unique values corresponding to associated field identifiers within the set of field identifiers.

8. The programmed method of claim 1, further comprising generating one or more result sets corresponding to time intervals specified in the summary criteria.

9. The programmed method of claim 1, wherein a field identifier comprises a segment size and a segment location within a trace entry.

10. The programmed method of claim 1, wherein scanning further comprises filtering the set of trace entries based on time stamp boundaries defined in the summary criteria.

11. The programmed method of claim 1, further comprising receiving a second summary criteria and generating at least one result set corresponding to each summary criteria such that the set of trace entries is scanned once.

12. The programmed method of claim 1, wherein scanning further comprises filtering the set of trace entries based on a trace identifier for specifying a trace entry type.

13. The programmed method of claim 1, wherein the one or more result sets are presented to a user.

14. The programmed method of claim 1, further comprising:
dividing an unstructured trace record logically into two or more trace entries based on structural information;
applying a query expression comprising a condition and one or more parameters to each entry; and
assembling each entry that satisfies the query expression into the set of trace entries.

15. A system for summarizing trace entry data, the system comprising:
a processor;
a storage device comprising a plurality of trace records;
Input/Output (I/O) devices configured to interact with a user;
an interface module configured to receive summary criteria comprising a set of field identifiers;
a scanning module configured to scan a set of trace entries;
a tabulating module configured to tabulate a count for each set of unique values within the set of trace entries, the unique values corresponding to associated field identifiers within the set of field identifiers; and
a results module configured to generate one or more result sets comprising the tabulated counts.

16. The system of claim 15, wherein the summary criteria is selectively defined by a user.

17. The system of claim 15, wherein the results module is further configured to generate one or more result sets corresponding to time intervals specified in the summary criteria.

18. The system of claim 15, wherein a field identifier comprises a segment size and a segment location within a trace entry.

19. A method for analyzing trace entry data, the method comprising:
executing a trend analysis utility comprising a plurality of modules, the modules comprising:
an interface module configured to receive summary criteria comprising a set of field identifiers;
a scanning module configured to scan a set of trace entries;
a tabulating module configured to tabulate a count for each set of unique values within the set of trace entries, the unique values corresponding to associated field identifiers within the set of field identifiers; and
a results module configured to generate one or more result sets comprising the tabulated counts; and
analyzing the one or more result sets to identify software operation trends indicated by the counts.

20. The method of claim 19, wherein the summary criteria is selectively defined by a user.
